(19) United States
(12) Patent Application Publication
(10) Pub. No.: US 2012/0303568 A1
(43) Pub. Date: Nov. 29, 2012

(54) DELIVERING RECOMMENDATIONS BASED ON USER CONTENT PROFILE

(75) Inventors: Keith W. Michel, Watertown, MA (US); Aron Ezra, San Francisco, CA (US); Slav Kulik, Mansfield, MA (US)

(73) Assignee: MACROVIEW LABS, INC., San Francisco, CA (US)

(21) Appl. No.: 13/115,849

(22) Filed: May 25, 2011

(51) Int. Cl. G06N 5/02

(52) U.S. Cl. 706/46

(57) ABSTRACT

In embodiments of the present invention, a request may be received at a web service facility. The request may be received from a handheld device and may include at least one of: at least one of: content details viewed by a user, content lists viewed by the user, bookmarked content stored by the user, content that may be rated by the user, various locations of usage of the handheld device, and handheld device actions. After the request has been received, the web service facility may process the request by an algorithm. Upon processing the request, the web service facility may send a response to the handheld device, wherein the response comprises at least one of: recommendations and predictions.

### TECHNICAL FIELD

The invention is generally related to communication between two electronic devices over a network, and particularly to communication between a web service and a client application.

### BACKGROUND

Mobile devices are used commonly to view media content such as images, videos, and the like. The media content may be stored in the mobile devices or may be accessed from a website. Users may view the media content by accessing a website. However, the media content such as images available on a website will be pre-defined in resolution, display size, and the like. When a user views the images from their mobile device, the resolution of the images may not be compatible with the resolution of the mobile device. This may result in blurred images being displayed to the user which may not be a pleasant experience for the user.

In addition, the users may download various applications on their mobile devices. The applications may be provided by different web service providers, thereby allowing the users to view/use the downloaded applications on the go. However, not all applications may be capable of running on every mobile device owing to some limitations such as different operating systems supporting devices, type of the application being downloaded, screen size, screen resolution, and the like. Further, users may not have knowledge about the requirements of all the applications. Finding out the requirement for each application and making them compatible with the mobile devices before proceeding to download applications may be inconvenient for the users.

Further, mobile devices facilitate users to share information with friends, peers, colleagues, and the like. The shared information may include content related to the needs and interests of the users. Mobile devices may also be used for searching information of interest. However, the users may either need to search through browsing-based lists or may need to conduct a plain-text search using their mobile devices. Conducting a search or checking the browsing history every time, for finding some information, may be tiresome for the users.

In view of the limitations discussed above, there exists a need for a system (web platform) that may be capable of overcoming these limitations.

### SUMMARY

In an aspect of the present invention, a method of interaction between a handheld device specific web service facility and a handheld device is provided. The method may include receiving a request at a web service facility. The request may be received from a client application facility that may be communicatively coupled to a handheld device. In an embodiment, the request may be made for displaying an image on the handheld device. Further, the request may include at least one of a source image Uniform Resource Locator (URL), a default viewport width, a default image width, a default image height, a requested viewport width, and the handheld device's screen resolution.

The method may further include processing the request at the web service facility. The processing may include checking if the received request is a repeat request or a new request. If the request is a new request, at least one of scaling a source image and resizing the source image may be performed. Thereafter, at least one of the scaled image and the resized image may be stored in a cache memory associated with the web service facility. The method may further include sending a response to the client application facility. The response may include at least one of a URL of the scaled image and a URL of the resized image. Further, the method may include searching at least one of a scaled image and the resized image in the cache memory when the received request is the repeat request.

In another aspect of the present invention, a method for providing a client application facility to a handheld device based on the operating system (OS) capabilities of the handheld device is provided. The method may include receiving a request at a web service facility. The request may be made by a handheld device. The request may be made for downloading a client application facility on the handheld device. Further, the request may include handheld device's OS capabilities. The method may further include processing the request at the web service facility. The processing may include applying an algorithm to analyze handheld device's OS capabilities. The method may also include designing a client application facility based on the analysis of the handheld device's OS capabilities. In addition, the method may include sending the designed client application facility to the handheld device.

In another aspect of the present invention, a request may be received by a web service facility. The request may include at least one of: content details viewed by a user, content lists viewed by the user, bookmarked content stored by the user, content for rating by the user, various locations of usage of the handheld device, and handheld device actions. The request may be processed at the web service facility. The request may be processed by an algorithm. A response may be sent by the web service facility to the handheld device. The response may comprise at least recommendations and/or predictions.

### BRIEF DESCRIPTION OF THE FIGURES

The invention and the following detailed description of certain embodiments thereof may be understood with reference to the following figures:

FIG. 1 depicts an overview of a multi-tier system for delivering content to mobile devices, in accordance with an embodiment of the invention;

FIG. 2 illustrates a system for facilitating display of images on different handheld devices of different resolutions, in accordance with an embodiment of the invention;

FIG. 3 depicts a system for making recommendations and predictions based on the characterization data of a user content profile, in accordance with an embodiment of the invention;

FIG. 4 depicts interaction of a handheld device with the web service facility, in accordance with an embodiment of the present invention;

FIG. 5 illustrates a method depicting an interaction between a handheld device specific web service facility and a handheld device, in accordance with an embodiment of the invention; and

FIG. 6 illustrates a method for providing a client application facility to a handheld device based on the Operating System (OS) capabilities of the handheld device, in accordance with an embodiment of the present invention

FIG. 7 illustrates a method for making recommendations and predictions based on the characterization data of a user content profile, in accordance with an embodiment of the invention.

### DETAILED DESCRIPTION

Detailed embodiments of the present invention are disclosed herein; however, it is to be understood that the disclosed embodiments are merely exemplary of the invention, which may be embodied in various forms. Therefore, specific structural and functional details disclosed herein are not to be interpreted as limiting, but merely as a basis for the claims and as a representative basis for teaching one skilled in the art to variously employ the present invention in virtually any appropriately detailed structure. Further, the terms and phrases used herein are not intended to be limiting, but rather to provide an understandable description of the invention.

The terms “a” or “an,” as used herein, are defined as one or more than one. The term “another,” as used herein, is defined as at least a second or more. The terms “including” and/or “having”, as used herein, are defined as comprising (i.e., open transition). The term “coupled” or “operatively coupled,” as used herein, is defined as connected, although not necessarily directly and not necessarily mechanically.

The present invention provides a multi-tier platform designed for organizations to deliver content to the mobile devices of their respective customer bases. The first tier is a device-specific application, which is in communication with a web service running on a scalable virtual platform and forming the second-tier of the multi-tier platform. The device specific application and the web service may together facilitate display of image files on mobile devices that may have different resolution screens. The system may further allow delivery of software applications of different resolutions to the mobile devices. The system may also facilitate the web service to provide recommendations to a user in response to the user request and based on the user content profile.

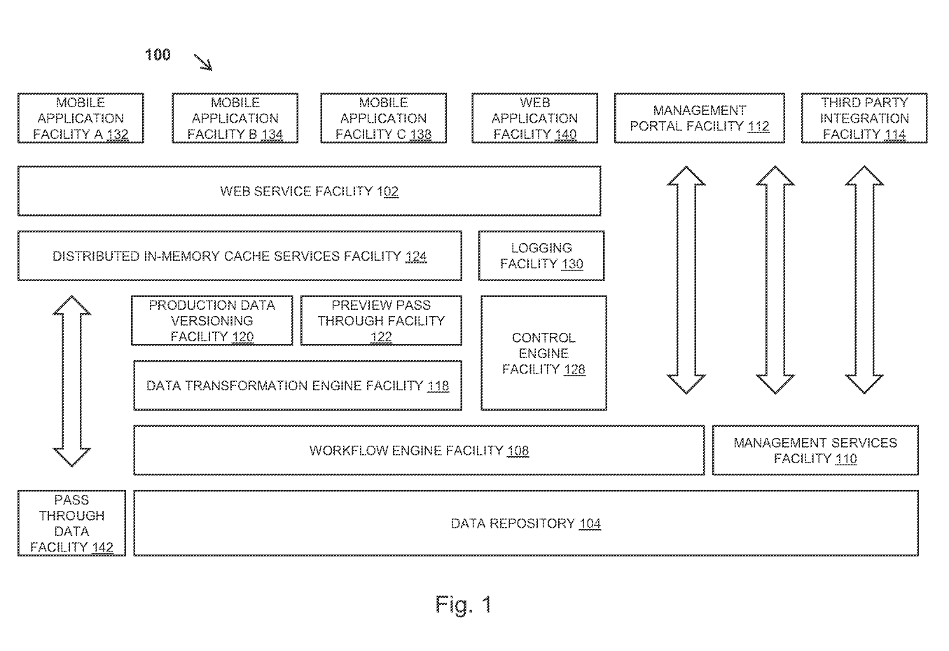

FIG. 1 depicts an overview of a multi-tier system 100 for delivering content to mobile devices, in accordance with an embodiment of the invention. The multi-tier system 100 may include, without any limitation, a web service facility 102, a data repository 104, a workflow engine facility 108, a management services facility 110, a management portal facility 112, a third-party integration facility 114, a data transformation engine facility 118, a production data versioning facility 120, a preview pass through facility 122, a distributed in-memory cache services facility 124, a control engine facility 128, a logging facility 130, a plurality of mobile application facilities 132-138, a web application facility 140, and a pass through data facility 142. The web service 102 may interact with client applications installed on the handheld devices (not shown in the FIG. 1).

The data repository 104 includes, without limitation, relational databases that house content management and configuration data. In an embodiment, the content management and the configuration data is associated with client applications installed in handheld devices. In examples, the types of data stored may include, but are not limited to, scheduled events, physical activities, news, photo tours, audio tours, video tours, dining locations, shopping locations, physical locations, phone contacts, email contacts, frequently asked questions, tutorials, and survey feedback forms. In examples, the content management and the configuration data associated with client applications may include the names of the applications, structure of the applications, navigation details, and the like. Further, the content management and the configuration data may be stored in the data repository 104 in an editable format. The management services facility 110 may include data for web service facility 102, and data and different business logic to communicate with the management portal facility 112. The management portal facility 112 may facilitate management of data and settings stored in the data repository 104 for each client application user. The management portal facility 112 may be secured by an authentication system. The management portal facility 112 may further logically sort a single client's data from any other client's data. The management portal facility 112 may also allow a user to enter new data; modify and delete existing data; and alter the meta data associated with the content that affects how and when the data is delivered to client applications. The management portal facility 112 may also provide both real-time and delayed analytic reports. The management services facility 110 may also interact with third party integration facility 114 and may facilitate access to data that may be from sources other than the data stored in the data repository 104. Examples of third party integrations may include, without any limitation, weather service APIs, calendar service APIs, and news feed APIs. In embodiments, the communication with the third-party integrations may be protected by authenticated requests over secure channels such as Secure Sockets Layer (SSL).

Once the data has been edited using the management portal facility 112, the work flow engine facility 108 may facilitate marking of the edited data that may be ready for the preview purpose and thereafter, may allow a user to authorize or give permission to publish the edited data. In an embodiment, the data that has been marked by the work flow engine facility 108 may only get published. In an embodiment, the data stored in the data repository 104 for editing may have a format different from that required to publish the data. The data transformation engine facility 118 may therefore allow transformation of the data into the desired format. Further, once the data has been published, the production data versioning facility 120 may label a version with the published data that may allow tracking of published data based on its different versions. The preview pass through facility 122 provides simulators that may facilitate preview of the data to be published.

The distributed in-memory cache services facility 124 may facilitate caching of data when the data is being transformed from one format to another. The distributed in-memory cache services facility 124 may continuously read this data and may share the load of this data to multiple servers so that the transformation process may be hastened. The distributed in-memory cache services facility 124 facilitates data for the web service facility 102. The web service facility 102 may act as the central repository and trafficker of the data. The web service facility 102 may constitute an application programming interface (API) with custom authentication protocols to allow secure access of the data. The web service facility 102 may be built with standards-compliant data communication protocols such as Extensible Markup Language (XML), Simple Object Access Protocol (SOAP), and Representational State Transfer (REST). The web service facility 102 may further respond to requests from other facilities in the system 100 to provide data in multiple formats, and to add, modify, and delete the data in some circumstances. The system 100 further includes a plurality of mobile application facilities 132-138 that may consume data from the web service facility 102. The mobile application facilities 132-138 may be designed in various programming languages such as Objective-C or Java. The mobile application facilities 132-138 may also originate sources of data from the handheld devices including geo-positioning data, authentication credentials, and content-specific request data. In embodiments, the mobile application facilities 132-138 may cache the data content in local databases (not shown in FIG. 1). This may speed up access to previously downloaded content at the handheld device and therefore, may improve the user experience of the application by displaying content more quickly. Further, the mobile application facilities 132-138 may be conversant in the communication protocols of the web service facility 102 to interpret and interact with objectified data transfers via the API. Also, the mobile application facilities 132-138 may be conversant with the handheld device operating system such that it may invoke system commands such as phone dialing or email client activation. The web application facility 140 may be a browser-based web application facility that may accommodate mobile devices incompatible with mobile application facilities 132-138. The web application facility 140 may deliver the content from the web service facility 102 via HyperText Markup Language (HTML) web pages.

The control engine facility 128 may act as a controller and may track all the facilities and data flow. The control engine facility 128 may also map different cache servers and applications. The logging facility 130 may record every request received at the system 100 and may report that for error logging and other types of analyses. The pass through data facility 142 may facilitate data syndication, for example, RSS feeds. The syndicated data may go to another system/server directly without being processed in the system 100.

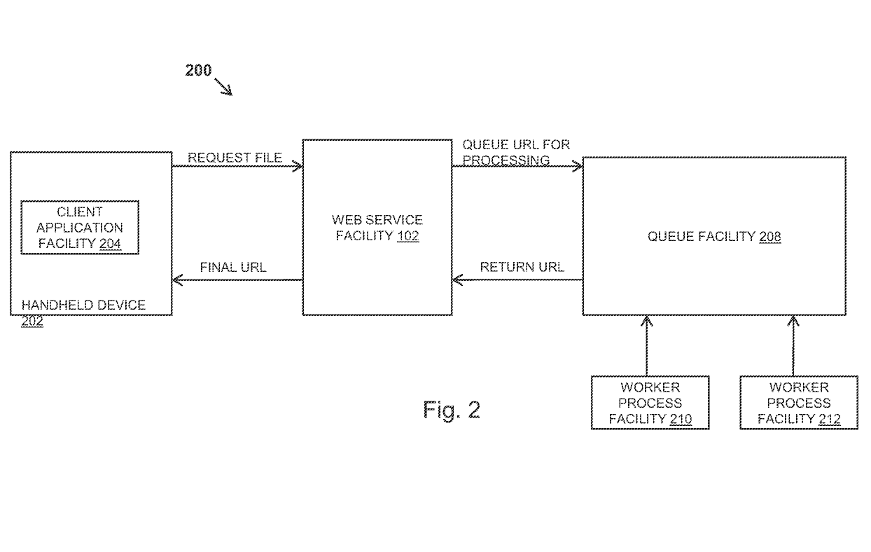

Referring to FIG. 2, a system 200 for facilitating display of images on different handheld devices of different resolutions is illustrated. The system includes a handheld device 202 that has a client application facility 204. The handheld device 202 may be, without any limitations, a mobile phone, a laptop, a tablet computer, and a Personal Digital Assistant (PDA). Further, the client application facility 204 may include various parameters of the handheld device 202 including, without limitations, viewport width, and screen resolution. In an embodiment, when an image is to be displayed on the handheld device 202, the client application facility 204 may send a request for the image to the web service facility 102. In an embodiment, the request sent by the client application facility may include source image Uniform Resource Identifier (URI), image size, and various parameters of the handheld device. On receiving the request from the client application facility 204, the web service facility 102 may verify whether the exact configuration of the requested file has been asked for/processed earlier. The configuration may include source image URL, image size, and various other parameters of the handheld device. In an embodiment, when the web service facility 102 determines that the requested image file has been requested earlier as well, the web service facility 102 may search the URL of the requested image in its cache and may return the correct or final URL of the requested image from its cache.

In another embodiment of the invention, when the web service facility 102 determines that the requested image file has not been requested before, the web service facility 102 may forward the request of the client application facility 204 to a queue facility 208. The request may be forwarded along with the source URL and the desired parameters associated with the handheld device 202. The request may then queue up into the queue facility 208 and may be taken up by the worker processes 210-212 for scaling or resizing the image on the basis of the parameters associated with the handheld device 202. It will be apparent to a person ordinarily skilled in the art that scaling or resizing the image on the basis of the parameters may be achieved by a processor associated with the system 200. In an embodiment, the processor may request additional parameters as well for scaling or resizing the image. The additional parameters may include, without limitations, default viewport width, default image width, and default image height. After the source image has been scaled and resized as per the parameters, the queue facility 208 may return the URL of the scaled and resized image to the web service facility 102. The web service facility 102 may then return the final URL to the client application facility 204. In an embodiment, the final URL may be sent along with parameters like height and width of the scaled and resized image. The client application facility 204 receives the final URL and related parameters and displays the image on the screen of the handheld device 202. In examples, the image file may be, without limitations, Portable Network Graphics (PNG), Joint Photographic Experts Group (JPEG), and Graphics Interchange Format (GIF). Further, the response of the web service facility 102 may be an XML structure.

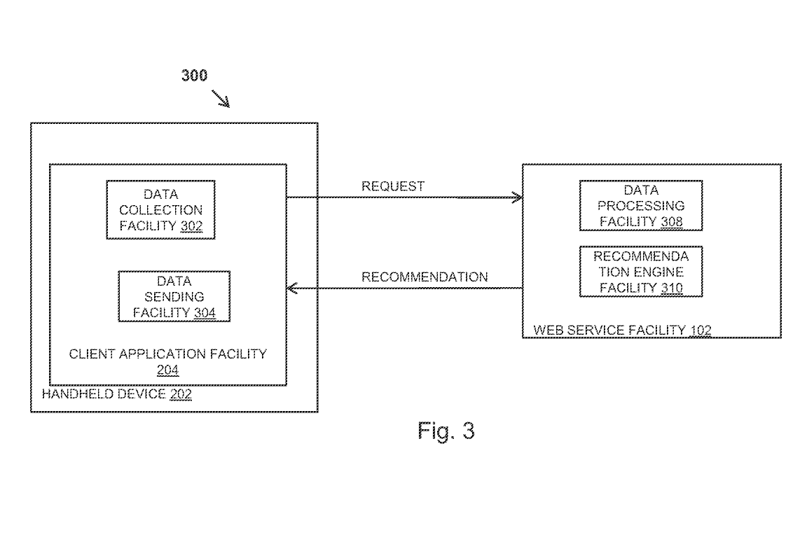

FIG. 3 depicts a system 300 for making recommendations and predictions based on the characterization data of a user content profile, in accordance with an embodiment of the invention. The system 300 includes the handheld device 202 configured to support the client application facility 204. The client application facility 204 may include a data collection facility 302 and a data sending facility 304. The data collection facility 302 may collect data associated with a user of the handheld device 202. The data may be based on the interactions among users, interaction of the user with a web server, and the like. In an example, the data may include content details viewed by a user, content lists viewed by a user, bookmarked content stored by the user, content for rating by the user, various locations of the usage of the handheld device, handheld device actions such as phone dialing based on the content, and the like.

In an embodiment, a user may search for some content using the handheld device 202. The client application facility 204 may send a request associated with the search to a web service facility 102. The data sending facility 304 may send the data collected by the data collection facility 302 to the web server facility 102 along with the search request. The web service facility 102 may include a data processing facility 308 and a recommendation engine facility 310. The data processing facility 308 may process the received data from the client application facility 204. Based on the received and processed data, the recommendation engine facility 310 of the web service facility 102 may provide recommendations or make predictions as a response to the request. In an embodiment, data such as user usage data and user preference data for multiple users may also be used for making recommendations and predictions about a user.

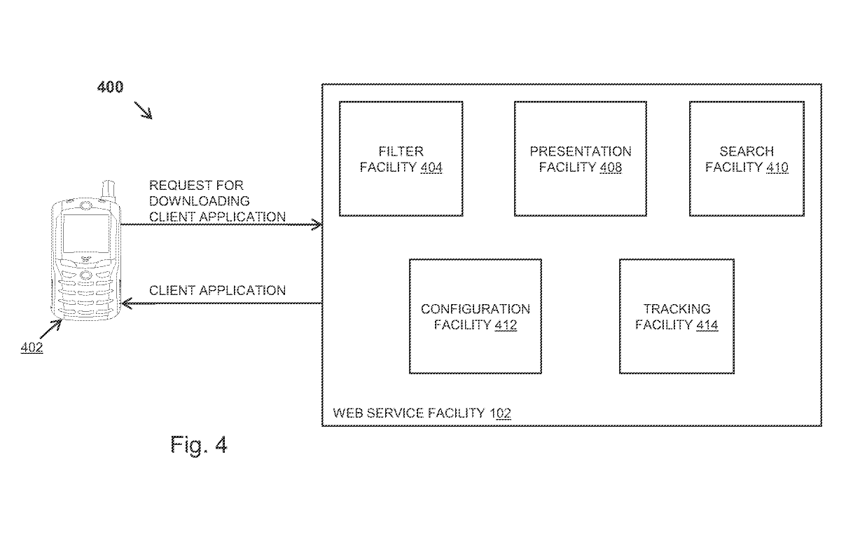

FIG. 4 illustrates the interaction of a handheld device 402 with the web service facility 102, in accordance with an embodiment of the present invention. The web service facility 102 may include a filter facility 404, a presentation facility 408, a search facility 410, a configuration facility 412, and a tracking facility 414.

The filter facility 404 facilitates delivery of the right type of data from the web service facility 102. The filter facility 404 may filter the delivery of the content based on different parameters including, without limitation, operating system platform of the handheld device 202, the type of the handheld device 202, the location of the handheld device 202 at the time of request initiation, time at which the request is initiated from the handheld device 202, and request for permissible content for the handheld device 202.

The presentation facility 408 may include a paging module (not shown). The paging module may facilitate a user to view a large volume of information requested by the user in the form of a plurality of pages. For example, if the user sends a request that results in a large volume of data, the paging module may break the data into pages which may display a portion of the results per page. The user may thereafter browse from page to page to see the data. Further, the presentation facility 408 may include a management module that may identify the data requested by the user. For example, if a user requests the exact information as asked in the user's last request, a web server may determine whether the latest data has been delivered to the user. In the case where the latest data has been delivered to the user, the web service facility 102 may facilitate the presentation facility 408 to send a message to the user indicating that the user has already received the latest data set for the request. In an embodiment, the presentation facility 408 may include a pre-bundling module that may club a dataset of the client application in itself. Accordingly, a user may quickly load the client application on their handheld devices without waiting for all the components of the client application to load.

Further, the search facility 410 may enable a user to search through the handheld device 202. The user may search by using keywords, may provide logic for searching data, use labels/bookmarks for searching content, and the like. The bookmarks may be saved by the user while interacting with the handheld device 202. In an embodiment, the users may also share labels provided to various datasets. The data may also be stored in dedicated folders that may show the user the entries marked by the labels.

The configuration facility 412 of the web service facility 102 may provide different layouts to the users. The configuration facility 412 may provide various aesthetic looks, different navigational schemes, and the like. The users may select from a list of themes while interacting with the web service facility 102. The themes may be provided by the configuration facility 412.

In addition, the tracking facility 414 of the web service facility 102 may track all interactions of the user with the web service facility 102. The tracking facility 414 may track the pages viewed by the user, the number of times a page is viewed, the duration of viewing a page, and the like. Further, the tracking facility 414 may also determine the durations of sessions between the user and the web service facility 102. Any request made by the user may also be tracked for viewing the kind of information requested by the user before sending the data.

Referring to FIG. 2, the client application facility 204 may visualize an action button which may invoke a content search request from the web service facility 102. Navigation within the client application facility 204 may be accomplished in this case through a series of action buttons that may correlate to segmentations of the user's data set. A higher-level navigation sequence may be visualized through another series of action buttons. Access to cached content may be accomplished via an action button. The content list may itself be a categorized, scrollable list of titles and summaries, which may sometimes contain additional information such as time and date. The content items that may be delivered by the web service facility 102 to these lists may also be determined in part by a timing mechanism, which may filter content viewing based on the current date and time. Additionally, a custom content trigger (that may be a string of letters and/or numbers entered by the user in the application's settings) may be transmitted to the web service facility 102 during content requests, and used to determine hidden or displayed targeted content.

The client application facility 204 may also have a mapping visualization. There may be an action button which may invoke a default view of the user's choosing, such as an aerial view of the institution location. A variation in navigational content may be visualized in the series of action buttons. An action button may invoke the handheld device's Global Positioning System (GPS) capability to locate the user's current geoposition on the map. The content in this case may be transmitted in the form of labeled geopositioning data.

The client application facility 204 may further have a content view. In an embodiment, there may be a navigational action button which may switch context of the view back to a content list. The content in this case may be depicted as text with embedded graphic elements. There may be an action button which may toggle the content as saved or unsaved in the handheld device's local data cache. Action buttons are examples of device-level feature invocations, such as phone dialing and email client activation. In another embodiment there may be a region of the screen dedicated to a user rating mechanism which may be optionally configured to appear in conjunction with certain content. These ratings may be collected and analyzed, and optionally displayed to the client or user.

The client application facility 204 may further have a bookmarks view. There may be an action button which may enable saved content to be re-ordered, categorized, or deleted. A variation in navigational content may be visualized in the series of action buttons. An action button may switch context of the view back to the previous screen. Content in this case may be the content list comprised of bookmarked items within the handheld device's cache. The bookmarked items which reference a scheduled event may be submitted to the web service facility 102 to invoke a push notification on the handheld device, depending on the user's notification preferences.

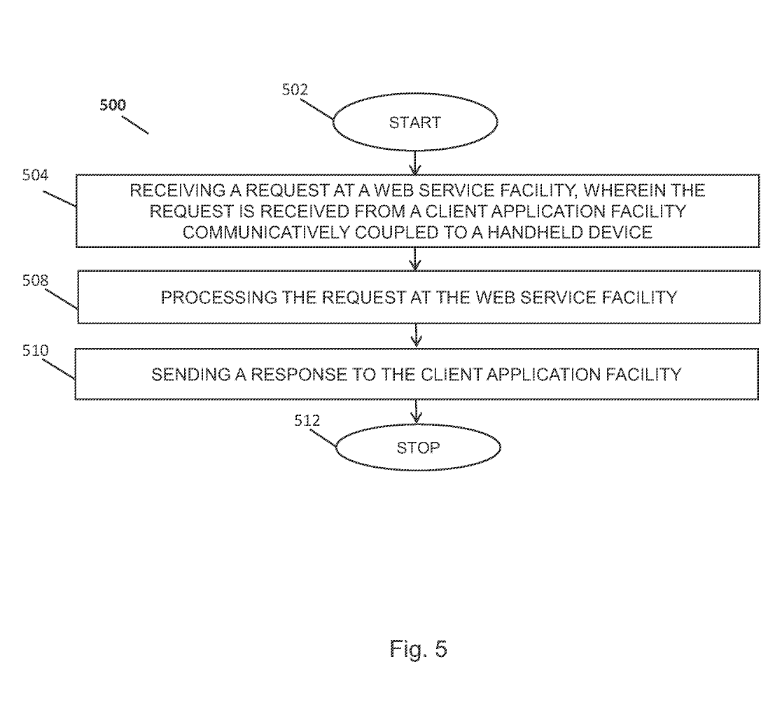

FIG. 5 illustrates a method 500 depicting interaction between a handheld device specific web service facility and a handheld device, in accordance with an embodiment of the invention. The method 500 initiates at step 502. At step 504, a request may be received at a web service facility. The request may be received from a client application facility that may be communicatively coupled with a handheld device. In an embodiment, the request may be made for displaying an image on the handheld device. The request may further include at least one of: a source image Uniform Resource Locator (URL), a default viewport width, a default image width, a default image height, a requested viewport width, and the handheld device's screen resolution. After the request has been received, at step 508, the web service facility may process the request. The processing may include checking if the received request is a repeat request or a new request. In an embodiment of the invention, if the received request is a new request, at least one of scaling a source image and resizing the source image may be performed. Thereafter, at least one of the scaled image and the resized image may be stored in a cache memory associated with the web service facility. In another embodiment the method may include searching at least one of a scaled image and the resized image in the cache memory when the received request is the repeat request. After the request has been processed, at step 510, the web service facility may send a response to the client application facility. The response may include at least one of: a URL of the scaled image, a URL of the resized image, and the like. The method 500 terminates at step 512.

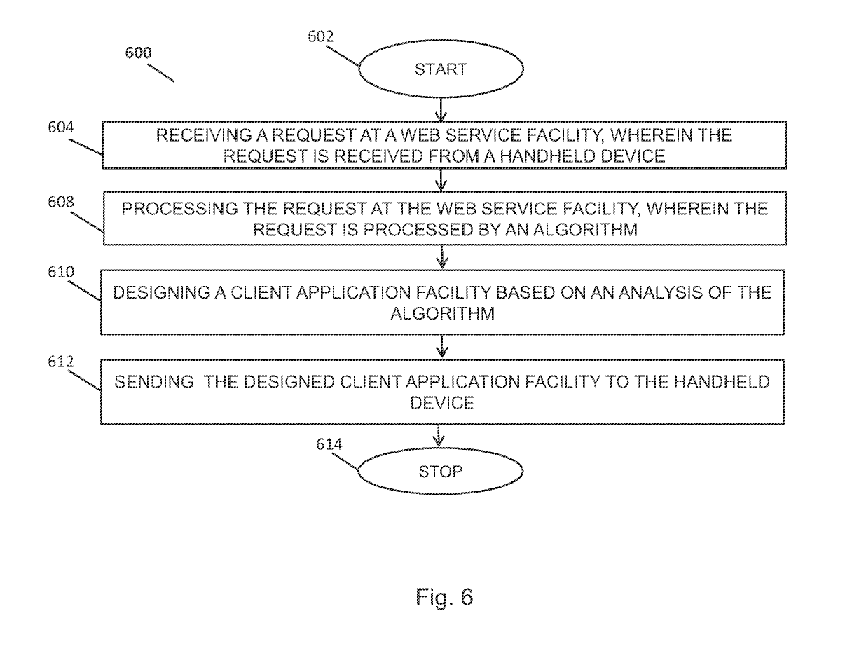

FIG. 6 illustrates a method 600 for providing a client application facility to a handheld device based on the operating system (OS) capabilities of the handheld device, in accordance with an embodiment of the present invention. The method 600 initiates at step 602. At step 604, a request may be received at a web service facility. The request may be sent by the handheld device. The request may be made by a user for downloading a client application facility on the handheld device. The request may include parameters associated with the OS capabilities of the handheld device. Further, at step 608, the request may be processed at the web service facility. The request may be processed by an algorithm. The algorithm may analyze the OS capabilities of the handheld device. Thereafter, at step 610, a client application facility may be designed for the handheld device, based on the analysis of the OS capabilities done by the algorithm. Further, at step 612, the designed client application facility may be sent to the handheld device. The method 600 terminates at step 614.

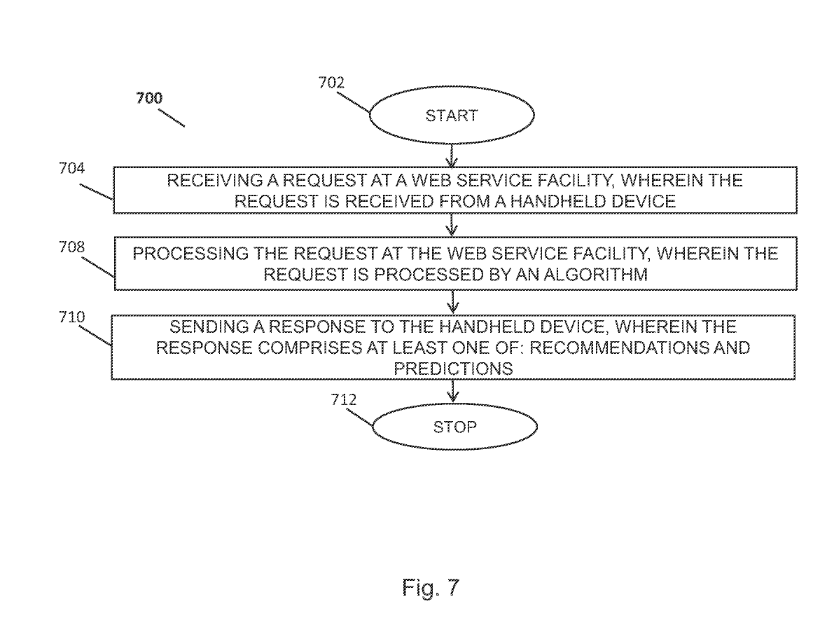

FIG. 7 illustrates a method 700 for making recommendations and predictions based on the characterization data of a user content profile, in accordance with an embodiment of the invention. The method 700 initiates at step 702. At step 704 a request may be received at a web service. The request may include at least one of: content details viewed by a user, content lists viewed by the user, bookmarked content stored by the user, content for rating by the user, various locations of usage of the handheld device, and handheld device actions. Thereafter at step 708, the request may be processed at the web service facility. The request may be processed by an algorithm. At step 710, a response may be sent by the web service facility to the handheld device. The response comprises at least one of: recommendations and predictions. The method 700 terminates at step 712.

The methods and systems described herein may be deployed in part or in whole through a machine that executes computer software, program codes, and/or instructions on a processor. The processor may be part of a server, client, network infrastructure, mobile computing platform, stationary computing platform, or other computing platform. A processor may be any kind of computational or processing device capable of executing program instructions, codes, binary instructions and the like. The processor may be or include a signal processor, digital processor, embedded processor, microprocessor or any variant such as a co-processor (math co-processor, graphic co-processor, communication co-processor and the like) and the like that may directly or indirectly facilitate execution of program code or program instructions stored thereon. In addition, the processor may enable execution of multiple programs, threads, and codes. The threads may be executed simultaneously to enhance the performance of the processor and to facilitate simultaneous operations of the application. By way of implementation, methods, program codes, program instructions and the like described herein may be implemented in one or more thread. The thread may spawn other threads that may have assigned priorities associated with them; the processor may execute these threads based on priority or any other order based on instructions provided in the program code. The processor may include memory that stores methods, codes, instructions and programs as described herein and elsewhere. The processor may access a storage medium through an interface that may store methods, codes, and instructions as described herein and elsewhere. The storage medium associated with the processor for storing methods, programs, codes, program instructions or other type of instructions capable of being executed by the computing or processing device may include but may not be limited to one or more of a CD-ROM, DVD, memory, hard disk, flash drive, RAM, ROM, cache and the like.

A processor may include one or more cores that may enhance speed and performance of a multiprocessor. In embodiments, the process may be a dual core processor, quad core processors, other chip-level multiprocessor and the like that combine two or more independent cores (called a die).

The methods and systems described herein may be deployed in part or in whole through a machine that executes computer software on a server, client, firewall, gateway, hub, router, or other such computer and/or networking hardware. The software program may be associated with a server that may include a file server, print server, domain server, internet server, intranet server and other variants such as secondary server, host server, distributed server and the like. The server may include one or more of memories, processors, computer readable media, storage media, ports (physical and virtual), communication devices, and interfaces capable of accessing other servers, clients, machines, and devices through a wired or a wireless medium, and the like. The methods, programs or codes as described herein and elsewhere may be executed by the server. In addition, other devices required for execution of methods as described in this application may be considered as a part of the infrastructure associated with the server.

The server may provide an interface to other devices including, without limitation, clients, other servers, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the server through an interface may include at least one storage medium capable of storing methods, programs, code and/or instructions. A central repository may provide program instructions to be executed on different devices. In this implementation, the remote repository may act as a storage medium for program code, instructions, and programs.

The software program may be associated with a client that may include a file client, print client, domain client, internet client, intranet client and other variants such as secondary client, host client, distributed client and the like. The client may include one or more of memories, processors, computer readable media, storage media, ports (physical and virtual), communication devices, and interfaces capable of accessing other clients, servers, machines, and devices through a wired or a wireless medium, and the like. The methods, programs or codes as described herein and elsewhere may be executed by the client. In addition, other devices required for execution of methods as described in this application may be considered as a part of the infrastructure associated with the client.

The client may provide an interface to other devices including, without limitation, servers, other clients, printers, database servers, print servers, file servers, communication servers, distributed servers and the like. Additionally, this coupling and/or connection may facilitate remote execution of program across the network. The networking of some or all of these devices may facilitate parallel processing of a program or method at one or more location without deviating from the scope of the invention. In addition, any of the devices attached to the client through an interface may include at least one storage medium capable of storing methods, programs, applications, code and/or instructions. A central repository may provide program instructions to be executed on different devices. In this implementation, the remote repository may act as a storage medium for program code, instructions, and programs.

The methods and systems described herein may be deployed in part or in whole through network infrastructures. The network infrastructure may include elements such as computing devices, servers, routers, hubs, firewalls, clients, personal computers, communication devices, routing devices and other active and passive devices, modules and/or components as known in the art. The computing and/or non-computing device(s) associated with the network infrastructure may include, apart from other components, a storage medium such as flash memory, buffer, stack, RAM, ROM and the like. The processes, methods, program codes, instructions described herein and elsewhere may be executed by one or more of the network infrastructural elements.

The methods, program codes, and instructions described herein and elsewhere may be implemented on a cellular network having multiple cells. The cellular network may either be frequency division multiple access (FDMA) network or code division multiple access (CDMA) network. The cellular network may include mobile devices, cell sites, base stations, repeaters, antennas, towers, and the like. The cell network may be a GSM, GPRS, 3G, EVDO, mesh, or other networks types.

The methods, programs codes, and instructions described herein and elsewhere may be implemented on or through mobile devices. The mobile devices may include navigation devices, cell phones, mobile phones, mobile personal digital assistants, laptops, palmtops, netbooks, pagers, electronic books readers, music players and the like. These devices may include, apart from other components, a storage medium such as a flash memory, buffer, RAM, ROM and one or more computing devices. The computing devices associated with mobile devices may be enabled to execute program codes, methods, and instructions stored thereon. Alternatively, the mobile devices may be configured to execute instructions in collaboration with other devices. The mobile devices may communicate with base stations interfaced with servers and configured to execute program codes. The mobile devices may communicate on a peer to peer network, mesh network, or other communications network. The program code may be stored on the storage medium associated with the server and executed by a computing device embedded within the server. The base station may include a computing device and a storage medium. The storage device may store program codes and instructions executed by the computing devices associated with the base station.

The computer software, program codes, and/or instructions may be stored and/or accessed on machine readable media that may include: computer components, devices, and recording media that retain digital data used for computing for some interval of time; semiconductor storage known as random access memory (RAM); mass storage typically for more permanent storage, such as optical discs, forms of magnetic storage like hard disks, tapes, drums, cards and other types; processor registers, cache memory, volatile memory, non-volatile memory; optical storage such as CD, DVD; removable media such as flash memory (e.g. USB sticks or keys), floppy disks, magnetic tape, paper tape, punch cards, standalone RAM disks, Zip drives, removable mass storage, off-line, and the like; other computer memory such as dynamic memory, static memory, read/write storage, mutable storage, read only, random access, sequential access, location addressable, file addressable, content addressable, network attached storage, storage area network, bar codes, magnetic ink, and the like.

The methods and systems described herein may transform physical and/or or intangible items from one state to another. The methods and systems described herein may also transform data representing physical and/or intangible items from one state to another.

The elements described and depicted herein, including in flow charts and block diagrams throughout the figures, imply logical boundaries between the elements. However, according to software or hardware engineering practices, the depicted elements and the functions thereof may be implemented on machines through computer executable media having a processor capable of executing program instructions stored thereon as a monolithic software structure, as standalone software modules, or as modules that employ external routines, code, services, and so forth, or any combination of these, and all such implementations may be within the scope of the present disclosure. Examples of such machines may include, but may not be limited to, personal digital assistants, laptops, personal computers, mobile phones, other handheld computing devices, medical equipment, wired or wireless communication devices, transducers, chips, calculators, satellites, tablet PCs, electronic books, gadgets, electronic devices, devices having artificial intelligence, computing devices, networking equipments, servers, routers and the like. Furthermore, the elements depicted in the flow chart and block diagrams or any other logical component may be implemented on a machine capable of executing program instructions. Thus, while the foregoing drawings and descriptions set forth functional aspects of the disclosed systems, no particular arrangement of software for implementing these functional aspects should be inferred from these descriptions unless explicitly stated or otherwise clear from the context. Similarly, it will be appreciated that the various steps identified and described above may be varied, and that the order of steps may be adapted to particular applications of the techniques disclosed herein. All such variations and modifications are intended to fall within the scope of this disclosure. As such, the depiction and/or description of an order for various steps should not be understood to require a particular order of execution for those steps, unless required by a particular application, or explicitly stated or otherwise clear from the context.

The methods and/or processes described above, and steps thereof, may be realized in hardware, software or any combination of hardware and software suitable for a particular application. The hardware may include a general purpose computer and/or dedicated computing device or specific computing device or particular aspect or component of a specific computing device. The processes may be realized in one or more microprocessors, microcontrollers, embedded microcontrollers, programmable digital signal processors or other programmable device, along with internal and/or external memory. The processes may also, or instead, be embodied in an application specific integrated circuit, a programmable gate array, programmable array logic, or any other device or combination of devices that may be configured to process electronic signals. It will further be appreciated that one or more of the processes may be realized as a computer executable code capable of being executed on a machine readable medium.

The computer executable code may be created using a structured programming language such as C, an object oriented programming language such as C++, or any other high-level or low-level programming language (including assembly languages, hardware description languages, and database programming languages and technologies) that may be stored, compiled or interpreted to run on one of the above devices, as well as heterogeneous combinations of processors, processor architectures, or combinations of different hardware and software, or any other machine capable of executing program instructions.

Thus, in one aspect, each method described above and combinations thereof may be embodied in computer executable code that, when executing on one or more computing devices, performs the steps thereof In another aspect, the methods may be embodied in systems that perform the steps thereof, and may be distributed across devices in a number of ways, or all of the functionality may be integrated into a dedicated, standalone device or other hardware. In another aspect, the means for performing the steps associated with the processes described above may include any of the hardware and/or software described above. All such permutations and combinations are intended to fall within the scope of the present disclosure.

While the invention has been disclosed in connection with the preferred embodiments shown and described in detail, various modifications and improvements thereon will become readily apparent to those skilled in the art. Accordingly, the spirit and scope of the present invention is not to be limited by the foregoing examples, but is to be understood in the broadest sense allowable by law.

All documents referenced herein are hereby incorporated by reference.

What is claimed is:

1. A method comprising:
receiving a request at a web service facility, wherein the request is received from a handheld device, further wherein the request comprises at least one of: content details viewed by a user, content lists viewed by the user, bookmarked content stored by the user, content for rating by the user, various locations of usage of the handheld device, and handheld device actions;
processing the request at the web service facility, wherein the request is processed by an algorithm; and
sending a response to the handheld device, wherein the response comprises at least one of: recommendations and predictions.
